(19) United States
(12) Patent Application Publication
(10) Pub. No.: US 2026/0307388 A1
(43) Pub. Date: Oct. 8, 2026

(54) MOLDED FLUIDIC DIES

(71) Applicant: Hewlett-Packard Development Company, L.P., Spring, TX (US)

(72) Inventors: Bo Song, Corvallis, OR (US); Chien-Hua Chen, Corvallis, OR (US); Michael G. Groh, Corvallis, OR (US)

(73) Assignee: Hewlett-Packard Development Company, L.P., Spring, TX (US)

(21) Appl. No.: 19/490,361

(22) PCT Filed: Jun. 8, 2023
(86) PCT No.: PCT/US2023/024879

§ 371 Date: Dec. 4, 2025

(51) Int. Cl. B41J 2/14; B41J 2/16

(52) U.S. Cl. CPC B41J 2/14145; B41J 2/1603; B41J 2/1637

(57) ABSTRACT

A method of forming a fluid flow structure in which a first fluidic die is molded into a molding material to form a molded die, and a second layer of molding material is molded onto the molded die, the second layer of molding material comprising a first fluid channel to deliver fluid to the first fluidic die.

### BACKGROUND

Fluidic dies refer to structures through which fluid may move through channels in a layer or layers of a material or a stack of materials. In the context of integrated circuits, a die refers to a block of semiconducting material comprising circuity components, a fluidic die may include fluidic, mechanical, and/or circuitry components. In the context of printing, one type of fluidic die includes fluid ejection dies. Fluid ejection dies may include small channels that carry fluid, such as ink, to ejection chambers, where the fluid is ejected from the die. The die may be molded into or otherwise coupled to a fluid distribution body, which delivers the fluid to the die. There may be other types of fluidic dies. For instance, and without limitation, in the context of lab-on-a-chip, a fluidic die may include circuitry and/or fluidic elements for mixing and separating, fluidic logic blocks, assays, and the like.

### BRIEF DESCRIPTION OF THE DRAWINGS

FIG. 1A is a cross-sectional side view of an example fluid flow structure.

FIG. 1B is a cross-sectional end view of the fluid flow structure of FIG. 1A.

FIG. 2A is an end view of an example fluidic die being molded into a fluid flow structure.

FIG. 2B is a cross-sectional end view of the fluidic die of FIG. 2A after being molded.

FIG. 3A is a side view of the fluidic die of FIG. 2A being molded.

FIG. 3B is a top view of the fluidic die of FIG. 2A after being molded.

FIGS. 4A-4C are cross-sectional end views of fluid flow structures, according to some examples.

FIG. 5A is a schematic flow diagram of a method of manufacturing fluid flow structures, according to some examples.

FIG. 5B is a schematic diagram of an example of the method of FIG. 5B.

FIGS, 6A and 6B are top views of fluid flow structures, according to some examples.

FIGS. 7A-7L are top views of fluid flow structures, according to some examples.

It will be recognized that the figures are schematic representations for purposes of illustration. The figures are provided for the purpose of illustrating the implementations with the explicit understanding that the figures will not be used to limit the scope of the meaning of the claims.

### DETAILED DESCRIPTION

Fluidic dies may be molded or otherwise coupled to a fluid distribution body to form a complete fluid flow structure. The fluid distribution body may have channels to deliver fluid to portions of the fluidic die. The fluid distribution body may be made of a layer or layers of molding material, such as epoxy mold compound. The fluidic die may be placed into a mold, and molding material may be poured or injected into the mold to form the fluid flow structure. The mold may include channel mold inserts or other raised features that form a negative of a channel or channels. When the molding material sets and the fluid flow structure is removed from the mold, the fluid distribution body is bonded to the fluidic die, with the channel or channels formed in the fluid distribution body.

As discussed above, the fluidic die may include circuitry and/or fluidic elements for mixing and separating, fluidic logic blocks, assays, and the like. In some examples, the fluidic die may be a lab-on-a-chip, and the fluid distribution body may deliver biological samples to specific portions of the lab-on-a-chip. For example, a first channel in the fluid distribution body may deliver a first biological sample to a first area of the lab-on-a-chip, and a second channel in the fluid distribution body may deliver a second biological sample to a second area of the lab-on-a-chip. In other examples, the fluidic die may be a fluid ejection die that ejects fluid from the fluid flow structure. For example, an inkjet printer may include fluid ejection dies (e.g., die slivers) that heat ink, to eject the ink from an ejection nozzle onto a surface or substrate, such as paper. Each fluid ejection die may include ink feed holes that deliver ink to ejection chambers, each of which include an ejection nozzle. The fluid ejection die may include circuitry that can deliver an electrical current to a resistor in each ejection chamber. The electrical current can heat the resistor, vaporizing some of the ink in the fluid ejection chamber and forcing ink out of the respective ejection nozzle. In some examples, the fluidic die may be a fluid ejection die used to eject particles of interest (e.g., cells, chemical samples, etc.) that can be dispensed into wells on a well plate for digital titration. In still other examples, the fluidic die may be a microelectromechanical system (MEMS device) that receives and analyzes or distributes fluid.

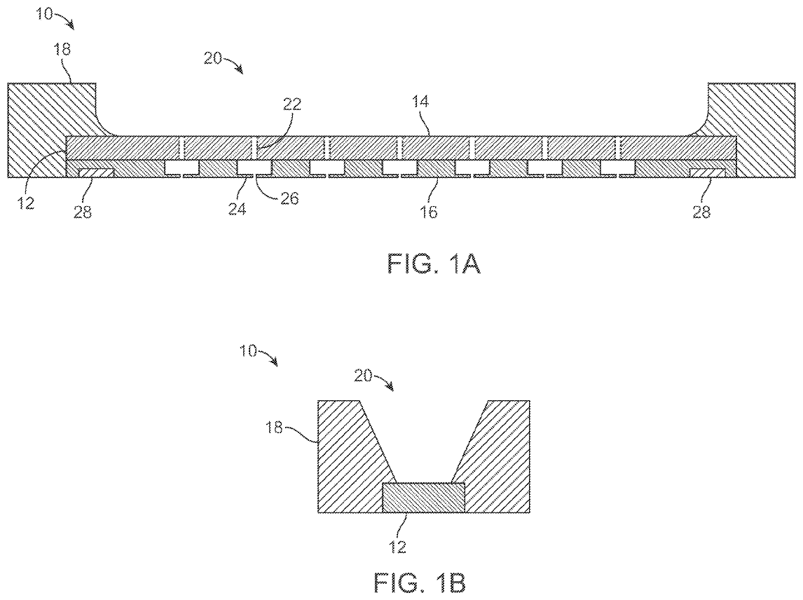

Referring now to FIGS. 1A and 1B, a cross-sectional side view and a cross-sectional end view of a fluid flow structure 10 are respectively shown, according to some examples. It should be understood that the figures are not to scale, and the size of several components have been enlarged for clarity. The fluid flow structure 10 may include a fluidic die 12. The fluidic die 12 of FIGS. 1A and 1B is shown as a fluid ejection die, for example, an ink ejection die for an inkjet printer. However, it should be understood that other types of fluidic dies 12, such as labs-on-a-chip or other MEMS devices may be similarly embedded into a fluid flow structure 10. The fluidic die 12 may be an elongated sliver with a length more than three times its width. As used herein, “length” refers to a distance along a horizontal axis as shown in FIG. 1A (e.g., along a longitudinal axis of the fluidic die 12), “width” refers to a distance along a horizontal axis as shown in FIG. 1B, and thickness refers to a length along a vertical axis as shown in FIG. 1A or FIG. 1B, unless otherwise specified. In some examples, the fluidic die 12 may include a substrate 14, which may be made of silicon, and an ejection layer 16. As discussed above, the fluidic die 12 may be molded into or otherwise coupled to a fluid distribution body 18. The fluid distribution body 18 may include a fluid channel 20 (e.g., a slot) that is fluidly coupled with fluid feed holes 22 in the substrate 14. The fluid feed holes 22 extend through the substrate 14 and are further fluidly coupled with the ejection chambers 24 in the ejection layer 16. Fluid may be supplied to the channel 20 and may travel through the fluid feed holes 22 to the ejection chambers 24. When an electrical current is supplied to a resistor positioned near the top of an ejection chamber 24, the resistor may rapidly heat up, causing fluid to be ejected from a nozzle 26 that is fluidly coupled with the ejection chamber 24. The ejection layer 16 may include bond pads 28 at each end to form electrical connections with electrical terminals of a control device, such as an inkjet printer body. The fluid flow structure 10 may be referred to as a fluid ejection device when the fluidic die 12 is a fluid ejection die, such as an ink ejection die for an inkjet printer.

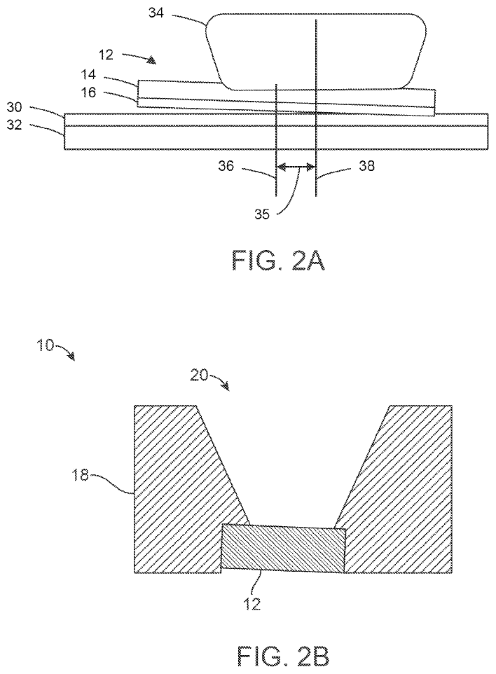

Referring now to FIG. 2A, an end view of the fluidic die 12 is shown in the process of being molded into a fluid distribution body 18 (e.g., as illustrated in FIG. 2B). To mold the fluidic die 12 into the fluid distribution body 18, the fluidic die 12 is first placed on a layer of thermal release tape 30 positioned on top of the carrier 32 (e.g., a copper carrier). Then, a channel mold insert 34 may be positioned on top of the ejection the 12 and clamped downward to eliminate any space between the fluidic die 12 and the channel mold insert 34. Next, material used to form the fluid distribution body 18 may be inserted (e.g., injected, poured, etc.) into a mold chamber, where it may surround the fluidic die 12 and the channel mold insert 34. The fluid distribution body 18 material may be, for example, epoxy mold compound (EMC). The thermal release tape 30 may be relatively soft and flexible, such that the thermal release tape 30 may compress when the channel mold insert is clamped onto the fluidic die 12.

As shown in FIG. 2A, an offset 35 (e.g., a horizontal offset) between a longitudinal axis 36 (e.g., a longitudinal centerline) of the fluidic die 12 and a longitudinal axis 38 (e.g., a longitudinal centerline) of the channel mold insert 34 may cause the fluidic die 12 to tilt as one side of the fluidic die 12 is pushed farther into the thermal release tape 30. In some examples, the other side of the fluidic die 12 may lift off of the thermal release tape 30. This may cause the EMC flash on the underside of the fluidic die 12, as EMC may flow between the thermal release tape 30 and the fluidic die 12 and bond to the underside of the fluidic die 12. This EMC flash may block fluid ejection nozzles 26 and portions of the bond pads 28 (see, e.g., FIG. 1A), which may interfere with electrical connections between the bond pads 28 and the printer body or other control device. FIG. 2B shows a cross-sectional end view of a fluid flow structure 10 molded with an offset 35 between the longitudinal axis 36 of the fluidic die 12 and the longitudinal axis 38 of the channel mold insert 34. As shown in FIG. 2B, the offset 35 may result in the fluidic die 12 being tilted along its longitudinal axis 36 relative to the fluid distribution body 18. This may cause fluid ejected from the nozzles 26 (see, e.g., FIG. 1A) to have a non-vertical trajectory, which can cause issues with print quality in inkjet printing applications. An offset 35 greater than 20 micrometers may cause enough tilt in the fluidic die 12 to cause EMC flash or print quality issues, which may lead to scrapping or undergoing expensive post-processing of the fluid flow structure 10 to remove EMC flash. Maintaining an offset below 20 micrometers may be difficult to achieve consistently due to manufacturing limitations.

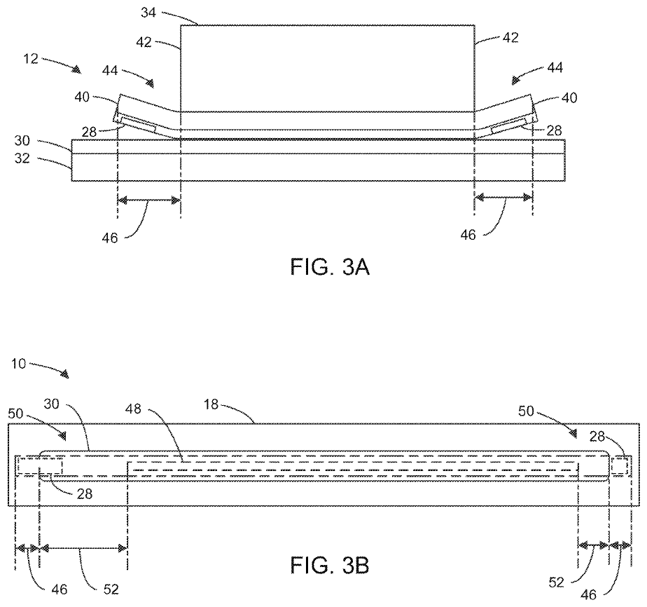

Referring now to FIG. 3A, a side view of the fluidic die 12 is shown in the process of being molded into a fluid distribution body 18. Because the fluid feed holes 22 (see, e.g., FIG. 1A) do not extend all the way to the ends 40 of the fluidic die 12, the channel 20 (see, e.g., FIG. 1A) also does not need to extend all the way to the ends 40 of the fluidic die 12. The portions of the fluidic die 12 that extend from the ends 40 of the fluidic die 12 to the ends 42 of the channel mold insert 34 may be referred to as cantilever portions 44, and the length of a cantilever portion 44 may be referred to as the cantilever distance 46. The cantilever distance 46 may be different at each end of the fluidic die 12. As discussed with regard to FIG. 2A the thermal release tape 30 may be relatively soft and flexible and may deflect downward when the channel mold insert 34 clamps down on the fluidic die 12. The ends 40 of the fluidic die 12 may lift off of the thermal release tape 30 due to the pressure from the channel mold insert 34, which may cause EMC flash under the cantilever portions 44 that can interfere with electrical connections to the bond pads 28. To prevent the ends 40 from lifting off the thermal release tape 30, the channel mold insert 34 may be made longer to reduce the cantilever distance 46. FIG. 3B shows a top view of a fluid flow structure 10. As can be seen in FIG. 3B, the channel 20 resulting from the longer channel mold insert 34 (see, e.g., FIG. 3A) extends past the region 48 where the fluid feed holes 22 are located. The fluid feed hole region 48 may be defined as the region of the fluidic die 12 between the fluid feed hole 22 closest to a first end 40 and the fluid feed hole 22 closest to the second end 40 (see, e.g., FIG. 1A). While the longer channel mold insert 34 may prevent EMC flash by reducing the cantilever distance, the resulting channel 20 includes large fluid (e.g., ink) dead zones 50 between the ends of the channel 20 and the ends of the fluid feed hole region 48. As shown in FIG. 3B, the fluid dead zone 50 has a length 52, which may or may not be the same at each end of the fluidic die 12. In inkjet printers, this ink dead zone 50 may affect the thermal management of the ink and may cause air bubble trapping that may affect print quality.

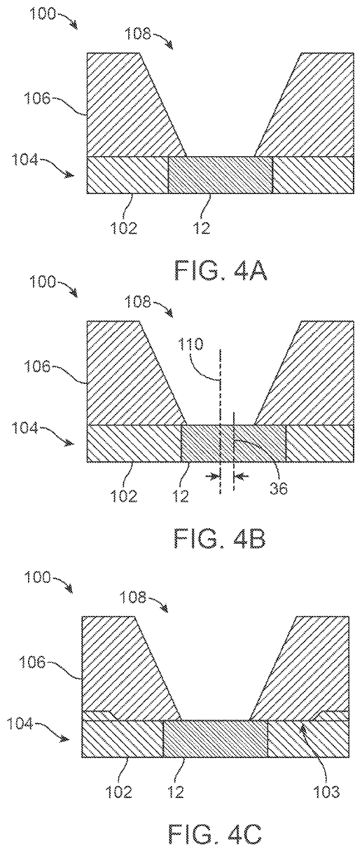

Referring now to FIGS. 4A-4C, cross sectional views of fluid flow structures 100 are shown, according to some examples. The fluid flow structure 100 includes a fluidic die 12 molded into a first layer 102 of molding material. The first layer 102 of molding material may include a region of molding material adjacent (e.g., surrounding) the fluidic die 12 that is substantially coplanar with an upper surface of the fluidic die 12. For example, the first layer 102 of molding material may be approximately the same thickness as the fluidic die 12, as shown in FIG. 4A. In other examples, the overall thickness of the first layer 102 of molding material may be thicker than the fluidic die but may include a region 103 surrounding the fluidic die 12 that is approximately the same thickness as the fluidic die 12, as shown in FIG. 4C. The first layer 102 may be molded without a channel mold insert 34 clamped onto the fluidic die 12, Because no channel mold insert 34 is used, the fluidic die 12 may remain flat on the thermal release tape 30. For example, an upper portion of the first layer 102 mold may cover the entire upper surface of the fluidic die 12 such that pressure is applied evenly over the entire upper surface. The fluidic die 12 molded into the first layer 102 of molding material may be referred to as a molded fluidic die 104 or a molded die 104.

After the fluidic die 12 is molded into the first layer 102 of molding material to form the molded fluidic die 104, a second layer 106 of molding material may be molded on top of the molded fluidic die 104. The second layer 106 may include a fluid channel 108 (e.g., a fluid distribution channel) to deliver fluid (e.g., ink, biological samples, etc.) to the fluidic die 12. The channel mold insert 34 used to create the channel 108 may be clamped down onto the molded fluidic die 104, but the first layer 102 of molding material bonded to the fluidic die 12 may reduce or eliminate the tilt caused by the clamping force due to any offset between the longitudinal axis 36 of the fluidic die 12 and a longitudinal axis 38 of the channel mold insert 34. As shown in FIG. 4B, the longitudinal axis 110 (e.g., the longitudinal centerline) of the channel 108 may be significantly offset from the longitudinal axis 36 of the fluidic die 12 without causing the fluidic die 12 to tilt along its longitudinal axis 36. In some examples, the first layer 102 of molding material may be made from a different material (e.g., a different type of epoxy mold compound) than the second layer 106 of molding material. In fluid flow structures with a single layer of molding material, differences in the coefficients of thermal expansion of the silicon in the fluidic die 12 and the molding material may cause the fluidic die 12 to warp or bow. A first layer 102 of molding material with a higher coefficient of thermal expansion than the second layer 106 of molding material may reduce the bowing of the fluidic die 12.

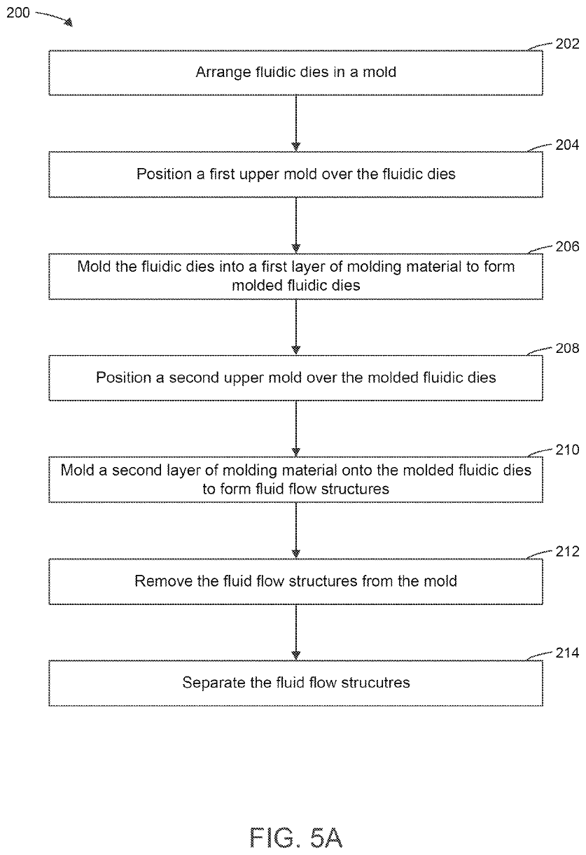

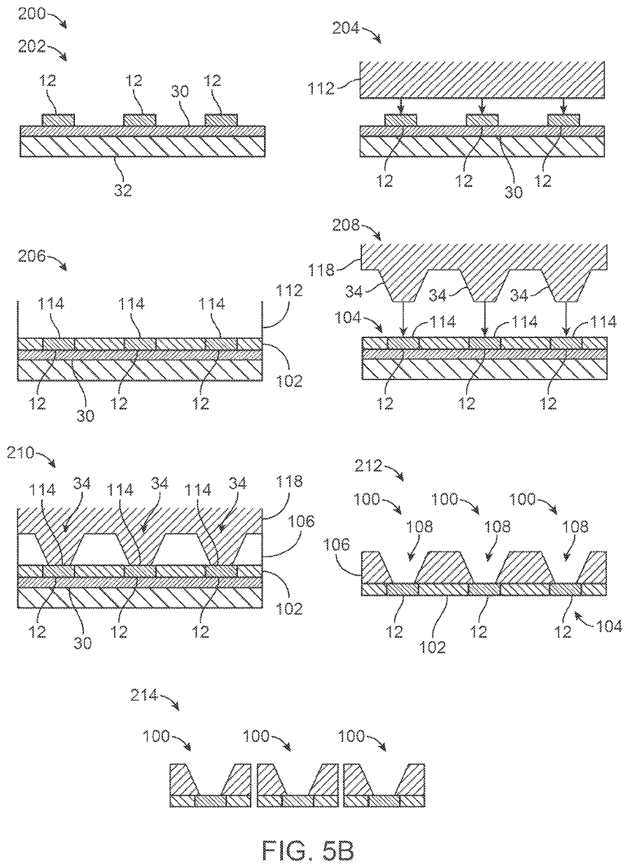

Referring now to FIG. 5A, a method 200 of manufacturing fluid flow structures 100 (e.g., the fluid flow structures 100 of FIGS. 4A-4C) is shown, according to some examples. At operation 202 of the method 200, fluidic dies (e.g., the fluidic dies 12 of FIGS. 4A-4C) are arranged in a mold. In some examples, the fluidic dies may be positioned on thermal release tape 30 inside the mold. The fluidic dies may initially be positioned within a lower mold without an upper mold initially attached. At operation 204 of the method 200, a first upper mold may be positioned over the fluidic dies. In some examples, the first upper mold may be positioned on the upper surfaces of the fluidic dies and may completely cover the upper surfaces. The fluidic dies may be clamped between the upper mold and the lower mold such that molding material inserted into the mold cannot reach the upper or lower surfaces of the fluidic dies. At operation 206 of the method 200, the fluidic dies may be molded into a first layer of molding material to form molded fluidic dies. The molding material may bond to the sides of the fluidic dies while blocked from reaching the upper and lower surfaces of fluidic dies by the upper and lower molds. In examples in which the upper mold completely covers the upper surface of the fluidic dies, the molded fluidic dies may include a region of molding material adjacent the fluidic dies that is substantially coplanar with the upper surface of the fluidic dies.

At operation 208 of the method 200, the second upper mold may be positioned over the molded fluidic dies. The second upper mold may include channel inserts for other raised features that form a negative of a channel or channels that will be formed in a second layer of molding material. The channel inserts or other features may contact regions of the fluidic dies such that the channels formed are fluidly coupled with the fluidic dies. The fluidic dies may be clamped between the upper mold and the lower mold such that molding material inserted into the mold cannot reach the lower surfaces of the fluidic dies and cannot reach the regions of the fluidic dies in contact with the upper mold. At operation 210 of the method 200, a second layer of molding material may be molded onto the molded fluidic dies, forming fluid channels around the channel inserts or other raised features of the upper mold. The second layer of molding material may bond to the first layer of molding material and/or to the fluidic dies, forming completed fluid flow structures (e.g., the fluid flow structures 10 of FIGS. 4A-4C). At operation 212 of the method 200, the fluid flow structures may be removed from the mold. If multiple fluid flow structures are molded in the same mold, the fluid flow structures may share a first layer of molding material and a second layer molding material, coupling the fluid flow structures together. At operation 214 of the method 200, fluid flow structures may be separated, for example, using a knife or saw. In some examples, multiple fluid flow structures may remain coupled together for installation and a control device such as an inkjet printer.

In some examples, the method 200 may include additional operations not explicitly listed. For example, the method 200 may include a third molding step, or may include transferring the molded fluidic dies to a second lower mold before molding the second layer of molding material. In some examples, not every listed operation of the method 200 may be performed. For example, in some cases, one fluid flow structure 100 may be manufactured according to the method 200 rather than multiple fluid flow structures 100, and operation 214 may not be performed.

Referring now to FIG. 5B, an example of the method 200 of manufacturing fluid flow structures 100 (e.g., the fluid flow structures 100 of FIGS. 4A-4C) is shown. At operation 202 of the method 200, fluidic dies 12 are arranged on thermal release tape 30. While three fluidic dies 12 are shown in FIG. 5B being molded into fluid flow structures 100, it should be understood that more or fewer fluidic dies 12 may be molded into fluid flow structures 100 simultaneously. At operation 204, a first upper mold 112 may be positioned on the upper surfaces 114 of the fluidic dies 12 and clamped down. The first upper mold 112 may prevent molding material from bonding to the upper surfaces 114 of the fluidic dies 12 or reduce the likelihood thereof. Because the first upper mold 112 covers the entire upper surfaces 114 of the fluidic dies 12, the pressure is spread evenly over the upper surfaces 114 and does not cause the fluidic dies 12 to tilt. At operation 206 of the method 200, the fluidic dies 12 may be molded into a molding material to form molded fluidic dies 104. For example, molding material may be added (e.g., poured, injected) into the first mold. The molding material may be, for example, epoxy molding compound (e.g., epoxy, epoxy resin). The molding material may surround and bond to the edges of the fluidic dies 12 to form molded fluidic dies 104 including a first layer 102 of molding material. As discussed above, the first layer 102 of molding material may be approximately equal to the thickness of the fluidic die 12, In other examples, the first layer 102 of molding material may be thicker than the fluidic die 12. In either case, a region of the molding material adjacent the fluidic dies 12 may be substantially coplanar with an upper surface 114 of the fluidic dies 12.

At operation 208 of the method 200, the second upper mold 118 may be positioned on the upper surfaces 114 of the fluidic dies 12 and clamped down. The second upper mold 118 may include channel mold inserts 34 for forming the channels 108. Because of the first layer 102 of molding material is surrounding and bonded to the fluidic dies 12, any offset between the longitudinal axis 36 of a fluidic die 12 and a longitudinal axis 38 of a channel mold insert 34 may not cause the fluidic die 12 to tilt. Further, the cantilever portions 44 of the fluidic dies 12 may not lift off of the thermal release tape 30 when the mold inserts 34 clamp down on the fluidic dies 12. This may allow for mold inserts 34, and therefore channels 108, that do not extend as close to the ends 40 of the fluidic dies 12, which may reduce the length of the fluid dead zones 50 in the channels 108. In some examples, as shown in FIG. 6A, the mold insert 34 and the channel 108 formed therefrom may not extend over the bond pads 28. For example, each bond pad 28 may extend a distance from an end 40 of the fluidic die 12, and the channel mold insert 34 may be positioned a distance from each end 40 of the die 12 that is greater than the distance that the respective bond pad 28 extends from the end 40. For example, one bond pad 28 may extend up to 1.6 mm from a first end 40 of a die 12, and a second bond pad 28 may extend up to 1.1 mm from a second end 40 of the die 12. The mold insert 34 may be positioned more than 1.6 mm from the first end 40 and more than 1.1 mm from the second end 40.

In some examples, as shown in FIG. 6B, the length of the fluid feed hole region 48 may be slightly less than the length of the channel mold insert 34 and the channel 108 formed therefrom. As used herein, the length being “slightly less” means more than of 98% of the length of the channel mold insert 34 or less than 0.4 mm shorter than the channel mold insert 34. For example, a fluid feed hole region 48 with a length of 9.7 mm is slightly shorter in length than a channel 108 with a length of 10.0 mm because the difference in length is less than 0.4 mm. As another example, a fluid feed hole region 48 with a length of 29.5 mm is slightly shorter in length than a channel 108 with a length of 30.0 mm because the length of the fluid feed hole region 48 is 98.3% of the length of the channel 108. In some examples, the channel 108 may be closer in length to the length of the fluid feed hole region 48 than to the length of the fluidic die 12. For example, if the fluidic die is 20.0 mm long and the fluid feed hole region 48 is 18.0 mm long, the channel 108 may be less than 19.0 mm long.

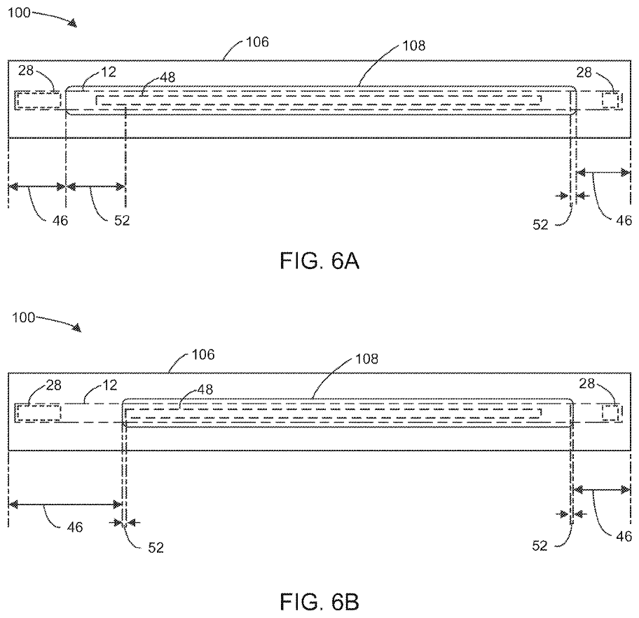

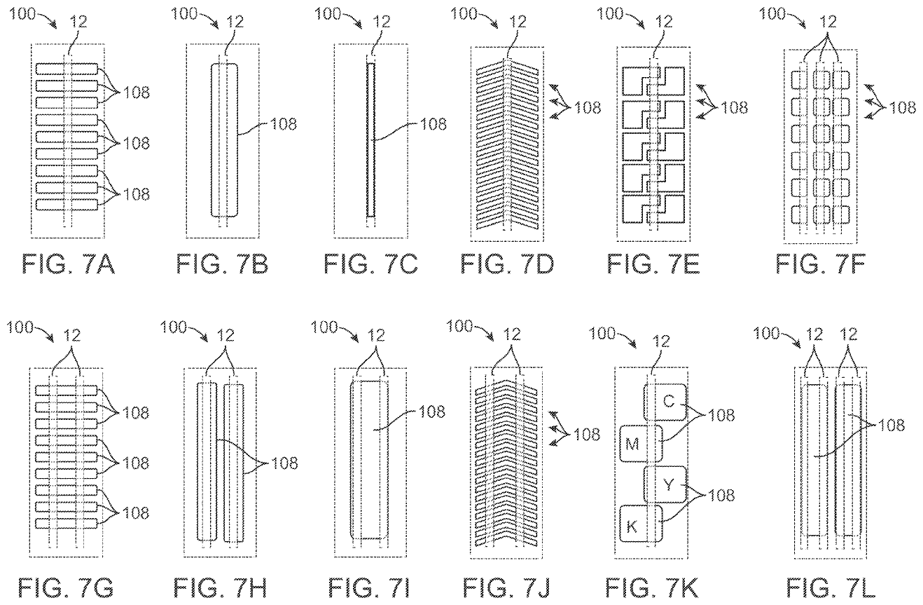

At operation 210 of the method 200, a second layer 106 of molding material is molded onto the molded dies 12. For example, molding material may be added (e.g., poured, injected) into the second mold. In the areas where the channel mold inserts 34 contact the upper surface 114, the second upper mold 118 may prevent molding material from bonding to the upper surfaces 114 of the fluidic dies 12 or reduce the likelihood thereof. The molding material may surround the channel mold inserts 34 to form the channels 108 arranged to deliver fluid to the fluidic dies 12. The molding material may bond to the molded fluidic dies 104 to form the second layer 106 of molding material and the completed fluid flow structures 100. At operation 212 of the method 200, the fluid flow structures 100 may be removed from the thermal release tape 30. At operation 214 of the method 200, the fluid flow structures 100 may be separated from each other using, for example, a saw. In some examples, multiple fluid flow structures 100 may remain coupled rather than being separated and may be installed in an inkjet printer body or other control device while still coupled together. In some examples, as discussed below with respect to FIGS. 7A-7L, the second upper mold 118 may include mold inserts 34 of various quantities, shapes, and sizes, such the second layer 106 of molding material may include multiple channels 108. In some examples, multiple channels 108 may be fluidly coupled with one fluidic die 12. In some examples, one channel 108 may be fluidly coupled with multiple fluidic dies 12.

Referring now to FIGS. 6A and 6B, top views of fluid flow structures 100 are shown, according to some examples. The fluid flow structures 100 of FIGS. 6A and 6B may be manufactured according to the method 200. As discussed above, because the fluidic dies 12 are surrounded by and bonded to the first layer 102 of molding material, pressure from the channel mold inserts 34 may not cause the cantilever portions 44 of the fluidic dies 12 to lift off of the thermal release tape 30. This may reduce or eliminate the likelihood of EMC flash blocking the bond pads 28, which allows the cantilever portions 44 to be longer than if a process with a single molding operation were used. Thus, a shorter mold insert 34 may be used and the length 52 of the fluid dead zones 50 in the channel 108 may be shorter than those of the fluid flow structures 10 manufactured using a process with a single molding operation,

In the fluid flow structure 100 of FIG. 6A, the length and position, relative to the fluidic die 12, of the channel mold insert 34 may be selected in such that the cantilever distance 46 is larger than the length of the bond pads 28. In some examples, the cantilever distance 46 may be equal such that the second layer 106 of molding material is substantially symmetrical. In some examples, the cantilever distances 46 may not be equal. As shown in FIG. 6A, the bond pads 28 have unequal lengths. The cantilever distance 46 may be larger than the length of the larger bond pad 28 and may be equal on both sides of the fluid flow structure 100. Increasing the cantilever distance 46 to a length longer than the bond pads 28 increases the amount of material above the bond pads 28 because the channel 108 does not extend above the bond pads 28. This may improve the structural robustness of the fluid flow structure 100 when wires are bonded to the bond pads 28. Increasing the cantilever distance 46 also reduces the length 52 of the fluid dead zone 50, which can reduce the likelihood of air bubbles in the fluid and thermal management of the fluid simpler. In inkjet printers, this may improve printing quality and performance.

In fluid flow structure 100 of FIG. 6B, the length and position, relative to the fluidic die 12, of the channel mold insert 34 may be selected in such that the cantilever distances 46 is maximized and the ink dead zones 50 are minimized or eliminated. The channel 108 may be slightly longer than the fluid feed hole region 48. Thus, fluid may be supplied in the areas where it is needed to supply the fluid feed holes 22 and not in other areas. As shown in FIG. 6B, the bond pads 28 and fluid feed hole region 48 are not symmetrical along the length of the fluidic die 12. Accordingly, the channel 108 may not be symmetrical along the length of the fluid flow structure 100, and the cantilever distances 46 of each end of the fluid flow structure 100 may be unequal. Instead, the length of the channel 108 may be determined based on the length of the fluid feed hole region 48 without regard to the cantilever distance 46.

Referring now to FIGS. 7A-7L, additional fluid flow structures 100 are shown, according to some examples. The methods discussed herein (e.g., the method 200), which include a second molding operation in which the fluid distribution channels are formed, may enable fluid flow structures 100 to be manufactured to include multiple fluid distributions channels 108 fluidly coupled to multiple fluidic dies 12, as well as channels 108 of various shapes and sizes. As shown in FIGS. 7A, 7D, 7E, and 7K, fluid flow structures 100 may include a single fluidic die 12 that is fluidly coupled with multiple channels 108. Each channel 108 may be fluidly coupled with a different portion of the fluidic die 12, and thereby fluidly coupled with different fluid feed holes 22, ejection chambers 24, and nozzles 26. In FIG. 7A, the fluid flow structure 100 includes several straight channels 108 fluidly coupled with one fluidic die 12. FIG. 7D shows a similar fluid flow structure 100 with angled channels 108 fluidly coupled with one fluidic die 12. FIG. 7E shows a similar fluid flow structure 100 with L-shaped channels 108 fluidly coupled with one fluidic die 12. This arrangement may allow for the channels 108 to retain a relatively large volume of fluid while being fluidly coupled with a relatively small portion of the fluidic die 12. FIG. 7K to the fluid flow structure 100 for an inkjet printer, including four fluid channels 108 for cyan, magenta, yellow, and black inks each connected to one fluidic die 12. Thus, one die 12 may be used to apply each color of ink. In addition to varying in shape, the fluid channels 108 may vary in size (e.g., width), as shown in FIGS. 7B and 7C, as needed for a specific application.

As shown in FIGS. 7F, 7G, 7H, 7I, 7J, and 7L, fluid flow structure 100 may include multiple fluidic dies 12. Each fluidic die 12 may be fluidly coupled with multiple fluid channels 108, and each fluid channel 108 may be fluidly coupled with multiple fluidic dies 12. FIG. 7F shows a fluid flow structure 100 with three fluidic dies 12, each of which are fluidly coupled with multiple fluid channels 108. As shown in FIG. 7F, each fluid channel 108 is coupled to one fluidic die 12. FIGS. 7G and 7J show fluid flow structures 100 with two fluidic dies 12 and multiple fluid channels 108. As shown in FIGS. 7G and 7J, each fluid channel 108 is coupled to both fluidic dies 12. As discussed above, the fluid channels 108 may be straight, as shown in FIG. 7G, angled, as shown in FIG. 7J, or any other shape. FIG. 7H shows a fluid flow structure 100 with two fluidic dies 12 and two fluid channels 108. Each fluidic die 12 is coupled to one of the fluid channels 108. FIG. 7I shows a fluid flow structure 100 two fluidic dies 12 each coupled to a single fluid channel 108. FIG. 7L shows the fluid flow structure 100 with four fluidic dies 12 and two fluid channels 108. Each fluid channel 108 is fluidly coupled to two fluidic dies 12. The various arrangements of fluid channels 108 and fluid ejections dies 12 shown in the fluid flow structures 100 of FIGS. 7A-7L may be useful in life-science applications, such as lab-on-a-chip, digital titration, and/or medical diagnostic applications. Each fluid distribution channel may receive a different biological sample according to the specific application. For example, a digital titration system may include a cassette including fluid ejection dies that eject particles of interest (e.g., cells, chemical samples, etc.) into wells on a well plate, where the particles of interest may react with other chemicals. The cassette may include fluid flow channels 108 as described above that deliver the particles of interest to the respective fluid ejection dies. The methods discussed herein enable fluid flow structures 100 that can be customized and tailored to specific applications.

In an aspect, a method of forming a fluid flow structure is provided, the method includes molding a first fluidic die into a molding material to form a molded die and molding a second layer of molding material onto the molded die, the second layer of molding material comprising a first fluid channel to deliver fluid to the first fluidic die.

In some examples, molding the first fluidic die into the molding material comprises forming a layer of molding material having a first thickness approximately equal to a second thickness of the first fluidic die.

In some examples, molding the first fluidic die into the molding material comprises forming a layer of molding material having a region of molding material adjacent the first fluidic die that is substantially coplanar with an upper surface of the first fluidic die.

In some examples, the method further includes positioning a channel mold insert on an upper surface of the first fluidic die before molding the second layer of molding material to form the first fluid channel. In some examples, the first fluidic die is a fluid ejection die comprising a plurality of fluid feed holes within a fluid feed hole region having a first length, wherein the first length is more than of 98% of a second length of the channel mold insert or less than 0.4 mm shorter than the second length. In some examples, the first fluidic die includes a first bond pad extending a first distance from a first end of the first fluidic die and a second bond pad extending a second distance from a second end of the first fluidic die. The channel mold insert is positioned a third distance from the first end of the first fluidic die and a fourth distance from the second end of the first fluidic die, the third distance greater than the first distance and the fourth distance greater than the second distance.

In some examples, the second layer of molding material further comprises a second fluid channel to deliver fluid to the first fluidic die.

In some examples, the method further includes molding a second fluidic die into the molding material along with the first fluidic die, wherein the first fluid channel is arranged to deliver fluid to both the first fluidic die and the second fluidic die.

In another aspect, a fluid flow structure is provided. The fluid flow structure includes a molded fluidic die including a first fluidic die molded into a first layer of molding material and a second layer of molding material coupled to the molded fluidic die and including a first fluid channel to deliver fluid to the first fluidic die.

In some examples, the first layer of molding material comprises a region of molding material adjacent the first fluidic die that is substantially coplanar with an upper surface of the first fluidic die.

In some examples, the first fluidic die is a fluid ejection die comprising a plurality of fluid feed holes within a fluid feed hole region having a first length, wherein the first length more than of 98% of a second length of the first fluid channel or less than 0.4 mm shorter than the second length.

In some examples, the first fluidic die includes a first bond pad extending a first distance from a first end of the first fluidic die and a second bond pad extending a second distance from a second end of the first fluidic die. The first fluid channel is positioned a third distance from the first end of the first fluidic die and a fourth distance from the second end of the first fluidic die, the third distance greater than the first distance and the fourth distance greater than the second distance.

In some examples, the fluid flow structure includes a second fluidic die molded into the first layer of molding material, and the first fluid channel is arranged to deliver fluid to both the first fluidic die and the second fluidic die.

In some examples, the second layer of molding material further includes a second fluid channel to deliver fluid to the first fluidic die.

In another aspect, a fluid ejection device is provided. The fluid ejection device includes a molded fluid ejection die including a first fluid ejection die molded into a first layer of molding material. The first layer of molding material includes a region of molding material adjacent the first fluid ejection die that is substantially coplanar with an upper surface of the first fluid ejection die. The fluid ejection device further includes a second layer of molding material coupled to the molded fluid ejection die and including a first fluid channel to deliver fluid to the first fluid ejection die. A first length of the channel is closer to a second length of a fluid feed hole region of the fluid ejection die than to a third length of the fluid ejection die.

It should be noted that certain passages of this disclosure may reference terms such as “first” and “second” in connection with devices, surfaces or sides of devices, modes of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

While this specification contains specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable sub-combination. Moreover, although features may be described as acting in certain combinations and even initially claimed as such, features from a claimed combination can, in some cases, be excised from the combination, and the claimed combination may be directed to a sub-combination or variation of a sub-combination.

As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other examples, and that such variations are intended to be encompassed by the present disclosure.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The foregoing description of illustrative examples has been presented for purposes of illustration and of description. It is not intended to be exhaustive or limiting with respect to the precise form disclosed, and modifications and variations are possible considering the above teachings or may be acquired from practice of the disclosed examples. It is intended that the scope of the claimed subject matter be defined by the claims appended hereto and their equivalents.

1. A method of forming a fluid flow structure, the method comprising:
molding a first fluidic die into a molding material to form a molded die; and
molding a second layer of molding material onto the molded die, the second layer of molding material comprising a first fluid channel to deliver fluid to the first fluidic die.

2. The method of claim 1, wherein molding the first fluidic die into the molding material comprises forming a layer of molding material having a first thickness approximately equal to a second thickness of the first fluidic die.

3. The method of claim 1, wherein molding the first fluidic die into the molding material comprises forming a layer of molding material having a region of molding material adjacent the first fluidic die that is substantially coplanar with an upper surface of the first fluidic die.

4. The method of claim 1, wherein further comprising positioning a channel mold insert on an upper surface of the first fluidic die before molding the second layer of molding material to form the first fluid channel.

5. The method of claim 4, wherein the first fluidic die is a fluid ejection die comprising a plurality of fluid feed holes within a fluid feed hole region having a first length, wherein the first length is more than of 98% of a second length of the channel mold insert or less than 0.4 mm shorter than the second length.

6. The method of claim 4, wherein the first fluidic die includes a first bond pad extending a first distance from a first end of the first fluidic die and a second bond pad extending a second distance from a second end of the first fluidic die, wherein the channel mold insert is positioned a third distance from the first end of the first fluidic die and a fourth distance from the second end of the first fluidic die, the third distance greater than the first distance and the fourth distance greater than the second distance.

7. The method of claim 1, wherein the second layer of molding material further comprises a second fluid channel to deliver fluid to the first fluidic die.

8. The method of claim 1, further comprising molding a second fluidic die into the molding material along with the first fluidic die, wherein the first fluid channel is arranged to deliver fluid to both the first fluidic die and the second fluidic die.

9. A fluid flow structure comprising:
a molded fluidic die comprising a first fluidic die molded into a first layer of molding material; and
a second layer of molding material coupled to the molded fluidic die and comprising a first fluid channel to deliver fluid to the first fluidic die.

10. The fluid flow structure of claim 9, wherein the first layer of molding material comprises a region of molding material adjacent the first fluidic die that is substantially coplanar with an upper surface of the first fluidic die.

11. The fluid flow structure of claim 9, wherein the first fluidic die is a fluid ejection die comprising a plurality of fluid feed holes within a fluid feed hole region having a first length, wherein the first length is more than of 98% of a second length of the first fluid channel or less than 0.4 mm shorter than the second length.

12. The fluid flow structure of claim 9, wherein the first fluidic die includes a first bond pad extending a first distance from a first end of the first fluidic die and a second bond pad extending a second distance from a second end of the first fluidic die, wherein the first fluid channel is positioned a third distance from the first end of the first fluidic die and a fourth distance from the second end of the first fluidic die, the third distance greater than the first distance and the fourth distance greater than the second distance.

13. The fluid flow structure of claim 9, further comprising a second fluidic die molded into the first layer of molding material, wherein the first fluid channel is arranged to deliver fluid to both the first fluidic die and the second fluidic die.

14. The fluid flow structure of claim 9, wherein the second layer of molding material further comprises a second fluid channel to deliver fluid to the first fluidic die.

15. A fluid ejection device comprising:
a molded fluid ejection die comprising a first fluid ejection die molded into a first layer of molding material, the first layer of molding material comprising a region of molding material adjacent the first fluid ejection die that is substantially coplanar with an upper surface of the first fluid ejection die; and
a second layer of molding material coupled to the molded fluid ejection die and comprising a first fluid channel to deliver fluid to the first fluid ejection die, wherein a first length of the channel is closer to a second length of a fluid feed hole region of the fluid ejection die than to a third length of the fluid ejection die.
